(19) United States
(12) Patent Application Publication
(10) Pub. No.: US 2003/0172778 A1
(43) Pub. Date: Sep. 18, 2003

(54) Flip top can opener

(76) Inventor: Earl A. Weaver, Scottsdale, AZ (US)

Correspondence Address: Earl A. Weaver, 7625 East Camelback Rd. 319 B, Scottsdale, AZ, 85251, US

(21) Appl. No.: 10/245,889

(22) Filed: Jan. 29, 2003

Related U.S. Application Data
(60) Provisional application No. 60/363,205, filed on Mar. 12, 2002.

(51) Int. Cl. B67B 7/16

(52) U.S. Cl. 81/3.55

(57) ABSTRACT

A LIFT-OFF can opener of unitary construction, manufactured from a composition of specifically reinforced plastic, via the injection molding process. The one and one-half inch slot in the end creates a fork concept that slides under and engages any size pull-tab on a can. A lifting upward of the opener breaks the seal on the can and a downward movement leveraging the opener on the opposite edge of the can imparts pressure to lift the entire lid from the can.

### FIELD OF INVENTION

The invention as submitted relates to a device for easy removal of Flip Top can lids now used on many food and drink products.

### BACKGROUND OF THE INVENTION

In recent years the packaging of many various foods have included a system including a Flip Top opener for the removal of can lids, as opposed to the time long method of cutting the perimeter of the lid with a hand operated or electric opener. This opener eliminates the possibility breaking finger nails and spillage when the Flip Top is removed by hand.

### DESCRIPTION OF DRAWINGS

FIG. 1. Opener engages Flip Top

FIG. 2. Breaking the can seal.

FIG. 3. Lifting and removing can lid.

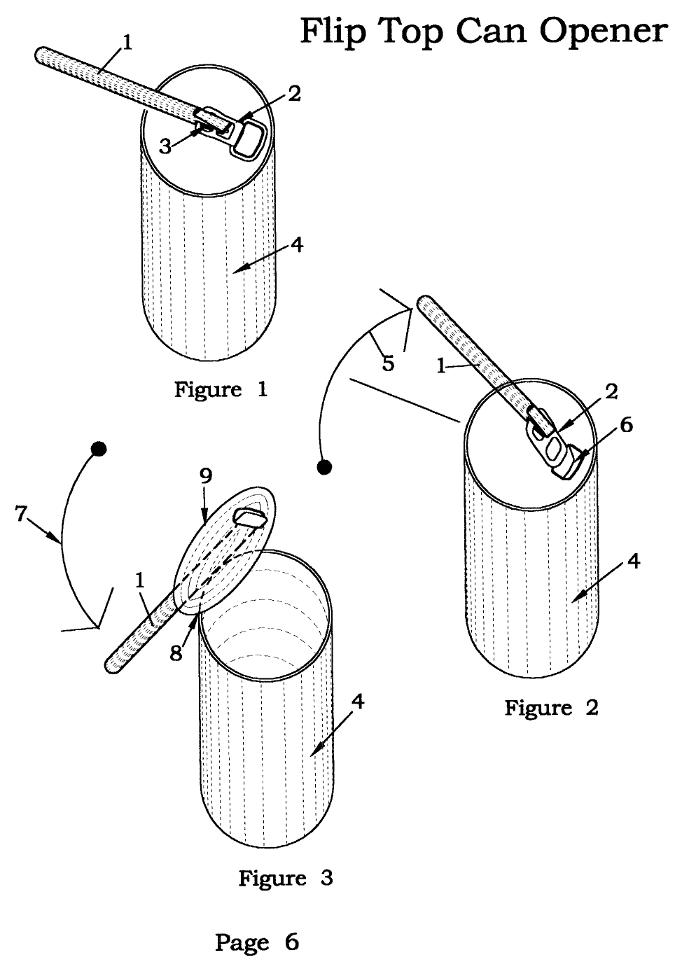

Referring to FIG. 1, The unitary opener (1) fully engages the cans (4) flip top (2) with the fork slot (3) of the opener (1).

FIG. 2. Holding the can in the other hand the opener (1) is then lowered in a downward motion (5) breaking the flip top (2) seal (6), with no broken finger nails.

FIG. 3. The opener (1) is then lowered in a downward motion (7). With the opener (1) in contact with the can (4), creating a leverage point at (8) lifting and removing the lid (9), with no spills.

The Lift-Off (NEWLY NAMED OPENER), indicated on page 2 of “Petition To Make Special, filed with the form Utility Patent Application Transmittal, application Ser. No. 10/245889, make the following claims.

1. The two pronged receptive fork slot with an engagement ability of one and one half inch pull tabs on the newly designed soup, juice, soda, beer and pet food cans has the following creative advantages over any other utensil available on the market at this time.
The one half inch-wide prongs are tapered to create a knife like devise so either prong will slide under the pull tab on a can and moving the opener forward the depth of the engaging area accepts the largest pull tab on any product as of this date.
A slight lifting of the handle portion of the opener creates a vise like grip on the tab and breaks the seal on the can, and with the second motion of the handle downward, leverages the opener on the opposit edge of the can, imparting presure, very easily removing the entire top from any product with this type of opening method.The Lift-Off opener is not only extremley easy to use, but a very quick means.
The elderly with arthritis, and/or any kind of weakness in their hands, can now buy all the products with the pull tabs, including the very small pet foods
All women that take care of those long fancy nails, and pay for those expensive manicures, no longer need to fear those pull tab products
